(19) United States
(12) Patent Application Publication
(10) Pub. No.: US 2025/0210337 A1
(43) Pub. Date: Jun. 26, 2025

(54) SPACER FOR AN ORIFICE ELEMENT

(71) Applicant: Thermo Fisher Scientific (Bremen) GmbH, Bremen (DE)

(72) Inventor: Jakub Magda, Bremen (DE)

(73) Assignee: Thermo Fisher Scientific (Bremen) GmbH, Bremen (DE)

(21) Appl. No.: 18/991,085

(22) Filed: Dec. 20, 2024

(30) Foreign Application Priority Data
Dec. 22, 2023 (GB) 2319888.0

(51) Int. Cl. H01J 49/06

(52) U.S. Cl. CPC H01J 49/068; H01J 49/067; H01J 2237/002; H01J 2237/036

(57) ABSTRACT

A spacer element is for an interface assembly comprising an orifice element defining an orifice for passing plasma from a plasma source and a cooling element for cooling the orifice element. The spacer element comprises an electrically isolating body configured to be inserted between the orifice element and the cooling element. The electrically isolating body is provided with an opening. An electrically conductive layer is provided on the electrically isolating body to face the orifice element.

### CROSS-REFERENCE TO RELATED APPLICATION

This application claims priority from UK patent application no. GB2319888.0, filed Dec. 22, 2023. The entire disclosure of GB2319888.0 is incorporated herein by reference.

### FIELD

This disclosure relates to a spacer for an orifice element of a spectrometry apparatus.

### BACKGROUND

A spectrometry apparatus, such as a mass spectrometer with inductively coupled plasma (ICP-MS), may include a hot plasma stream which vaporises and ionizes a sample, so that ions from the sample can then be processed or introduced to the spectrometer for measurement or analysis. The extraction and transfer of ions from the plasma involves directing a fraction of the ions formed by the plasma through an interface assembly, which facilitates bridging of the pressure difference between the plasma source and the spectrometer. The interface assembly may include a first orifice provided in a sampler, and then a second, often narrower, orifice provided in a skimmer (typically referred to as sampler and skimmer cones respectively).

In a conventional spectrometry apparatus, the sampler and the skimmer are usually grounded. However, a spectrometry apparatus can also be operated such that one or both of the sampler and the skimmer are not grounded. Furthermore, a spectrometer apparatus typically requires a vacuum in which to operate, and the plasma stream must be maintained at very high temperatures of up to 10,000K. The components within the spectrometry apparatus, particularly in the interface assembly, must therefore be regulated and must withstand the harsh conditions imposed by the hot plasma, without interfering with the ion transfer or negatively influencing measurement and analysis.

There is therefore a large number of different technical (e.g., electrical, thermal, and material) requirements that must be met within the spectrometry apparatus, which can lead to conflicting design requirements.

### SUMMARY

The inventor has realised that the conflicting design requirements discussed above can be addressed by providing a spacer element in the interface assembly to electrically isolate an orifice element from the rest of the interface assembly, whilst also making an electrical connection with the orifice element. This is achieved by providing a spacer element, as detailed below, between the orifice element and a cooling element, such as a cooling plate, of the interface assembly to facilitate an isolated electrical connection to the orifice element whilst maintaining sufficient heat transfer from the orifice element to the cooling element.

In a first implementation, a spacer element for a plasma interface assembly in a spectrometry apparatus is provided. The plasma interface comprises an orifice element defining an orifice for passing plasma (or charged ions in the plasma) from a plasma source, and a cooling element for cooling the orifice element. In use, the plasma flows through the plasma interface into a spectrometer, such as for mass spectrometer. In particular, the apparatus may be, for example, a mass spectrometry apparatus or an optical spectrometry apparatus.

The spacer element comprises an electrically isolating body configured to be inserted between the orifice element and the cooling element. In this way, the spacer element electrically isolates the orifice element to prevent unwanted movement of electrical charge across components in the apparatus, which could lead to change in electric fields or interference with the charged ions in the interface, calibration or measurement interference, component damage, or safety risks. The electrically isolating body is provided with an opening, which facilitates the positioning of the body between and around the orifice element and the cooling element. The electrically isolating body may be planar, within reasonable manufacturing tolerances, so that it conforms to or with the orifice element and/or the cooling element. Beneficially, this allows a secure fit between the components of the interface assembly to minimise spacing between the components of the interface assembly. The opening of the electrically isolating body may be any space or gap in the body through which ions generated the plasma source may flow.

The spacer element also comprises an electrically conductive layer provided on the electrically isolating body to face the orifice element. In this way, when the electrically isolating body is inserted between an orifice element and the cooling element, the electrically conductive layer can electrically couple with the orifice element. The layered configuration of the spacer element enables electrical conduction with the orifice element without any electrical contact with the cooling element, so as to electrically communicate with the orifice element whilst preventing electrical interference with other components of the spectrometry assembly. In this way, a voltage may be applied to the orifice element to create a field having a selected bias voltage in a portion of the interface assembly. For example, the intensity of the ion flow from the plasma source may be increased by passing the ions through a field biased in a desired direction.

The spacer element may comprise a contact tab which extends from the electrically conductive layer and is configured to act as an electrical contact to facilitate an electrical connection with the electrically conductive layer. The contact tab may be provided on a corresponding extending portion of the electrically isolating body. In some examples, the contact tab extends generally in a plane of the spacer element and substantially radially outward from the electrically conductive layer, such as at a right angle, or may extend at any angle in the plane away from the electrically conductive layer, such as in a direction away from or through the electrically isolating body.

The electrically isolating body may be substantially annular or ring-shaped to accommodate a common form factor of the orifice element and allow plasma and/or ions to pass through the opening when the spacer element is placed between and around the orifice element and the cooling element. For example, the electrically isolating body may be any of a closed-ring shape, a C-shape, an oval, or a square. In some examples, the shape of the electrically isolating body conforms with shape of the cooling element, the orifice element, or other components of the interface assembly.

The electrically isolating body may be 90 to 110 μm thick, or may be thicker than 110 μm, e.g. 150 μm, or thinner than 90 μm, e.g., 50 μm. It will be appreciated that minimising the thickness of the electrically isolating body provides a higher thermal conductance and maximises the cooling of the orifice element with the cooling element. For a desired heat regulation, a balance can be struck. For example, the electrically isolating body may have a lower thickness in implementations with materials of a limited intrinsic thermal conductivity, or may have a higher thickness in implementations with materials of higher thermal conductivity. One example of an electrically isolating body with sufficient heat transfer properties is a polyimide layer or plate, e.g., Kapton®.

The electrically conductive layer may comprise any conductive material known in the art, such as copper. For example, the layer may comprise copper foil and/or may comprise copper tracks disposed on the surface of the electrically isolating layer. The total thickness of the spacer may be less than 1 mm. The electrically conductive layer may be 30 μm to 40 μm thick, for example.

In some examples, the spacer element further comprises a gold layer disposed on the conductive layer. Beneficially, by providing a gold layer on the conductive layer, e.g. on copper tracks, this renders the conductive layer inert and enables use of the spacer in the direct vicinity of the plasma in a vacuum. In some examples, the gold layer is 2 μm to 5 μm thick. Nevertheless, it will be appreciated that thicker than 5 μm gold layers may also be used. The gold layer is electrically conductive, thus electrical conduction between the electrically conductive layer and the orifice element is maintained.

The spacer element, as described herein, electrically serves to isolate the orifice element from other components of the interface assembly, whilst enabling an electrical connection to be made with the orifice element. In addition, the material geometries of the spacer ring may facilitate thermal conductance and enable sufficient cooling of the orifice element with the cooling element. In this way, the spacer ring advantageously combines the contradicting properties of electrical insulation and thermal conductivity. For example, the spacer ring may have a total thickness of 135 μm, plus or minus 15 μm. In other examples, the spacer element may have a thickness higher than 135 μm (e.g., a thickness of 1 mm, substantiated by a higher thickness of the conductive copper and/or a higher thickness of the electrically isolating body), whilst still maintaining a sufficient thermal conductance. Crucially, the materials and the respective geometries of the spacer element are provided to maintain the operating temperature of the orifice element and the surrounding components by cooling of the components through the cooling element. For example, the spacer element may have a thermal conductance of 0.1 to 0.5 Watts per Meter-Kelvin. It will be appreciated that higher or lower thermal conductance are also possible, depending on the specific materials use or the design of the interface assembly.

In some examples, the spacer element further comprises through-holes to accommodate fixings in the interface assembly. The through-holes may be positioned around the periphery of the spacer element. The fixings secure the orifice element to the cooling element, and the spacer element therebetween, and may comprise any suitable fixings known in the art, such as bolts, screws, or rivets.

In another implementation, an interface assembly for a spectrometer comprises an orifice element disposed on a cooling element (such as a cooling plate). The cooling element may be gas or liquid cooled through coolant channels in the cooling plate, e.g., with water at a temperature of 15° C. to 25° C. A spacer element, as described above, is positioned between the orifice element and the cooling element. Additionally, the interface assembly comprises an electrical lead for supplying a voltage to the orifice element, the electrical lead being connected to the spacer element. The spacer element may be removably fixed between the orifice element and the cooling element, which advantageously enables ease of replacement of the spacer element.

In some examples, the orifice element may comprise one or a combination of a skimmer and a sampler. The skimmer and sampler may be a skimmer cone and a sampler cone respectively, or they may be formed of other suitable shapes known to the skilled person.

In some examples, the orifice element may comprise a plurality of component parts, such as a skimmer and a skimmer holder. Alternatively, the orifice element may be a single workpiece and/or an orifice element holder may be part of another structure of the spectrometry apparatus. In both such examples, the spacer element is positioned in a location between the orifice element and the cooling element, so as to electrically isolate the orifice element whilst enabling an electrical connection thereto.

In another implementation, a spectrometry apparatus comprises the interface assembly and the spacer element as described above. The spectrometry apparatus may be a mass spectrometer or an optical spectrometer. For example, the apparatus may be a mass spectrometer with inductively coupled plasma (ICP-MS), or alternatively the apparatus may be an optical spectrometry system with inductively coupled plasma, e.g., for inductively coupled plasma optical emission spectroscopy (ICP-OES).

### BRIEF DESCRIPTION OF THE DRAWINGS

Disclosed implementations will now be described by way of example to illustrate aspects of the disclosure and with reference to the accompanying drawings, in which:

FIG. 1 illustrates a top view of an interface assembly for a spectrometry apparatus.

FIG. 2 illustrates a cross-sectional view of the interface assembly of FIG. 1 along the section line indicated in FIG. 1.

FIG. 3 illustrates a side elevation of the interface assembly of FIG. 1.

FIG. 4 illustrates an exploded view of the interface assembly of FIG. 1.

FIG. 5A illustrates top view of a spacer element for a plasma interface assembly.

FIG. 5B illustrates a bottom view of the spacer element of FIG. 5A.

FIG. 6 illustrates a cross-sectional view of the spacer element of FIG. 5A.

### DETAILED DESCRIPTION

For brevity, the specific description below will be described with reference to an inductively coupled plasma mass spectrometry (ICP-MS) apparatus. However, it will be appreciated that the present disclosure is readily applied to a plasma interface assembly for any known spectrometry apparatus, e.g., for optical emission spectrometry or mass spectrometry.

The environment at the interface within an ICP-MS apparatus can be particularly harsh, with high temperatures, a substantial pressure differential, charged plasma flow, geometric limitations, and thermal/electrical conduction criteria. The spacer element 200 combines these requirements with one component having various technical properties, such as: functionality in close proximity to charged plasma; functionality in high temperatures; functionality in a vacuum; being inert or unreactive so as not to influence the sample; electrical isolation; thermal conductivity; constant and minimal spacing between components of the interface assembly; easy replaceability; and economical manufacturability.

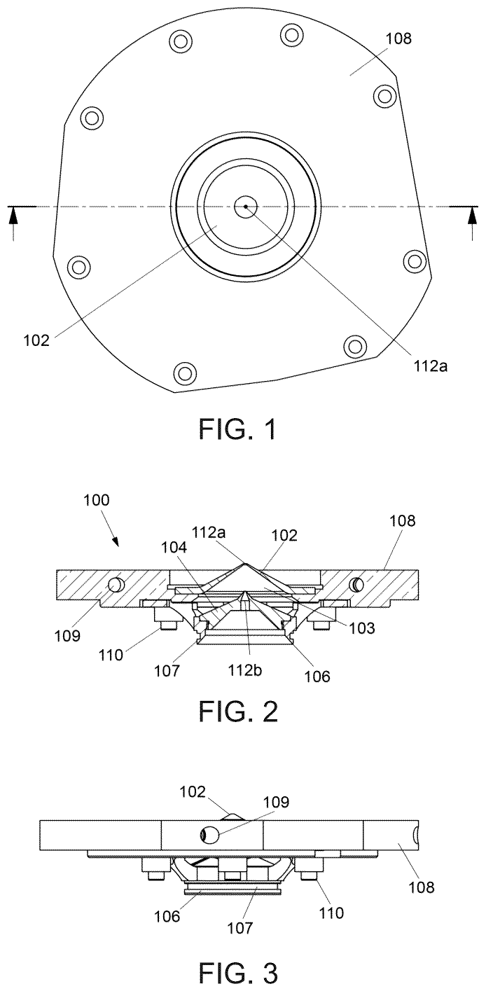

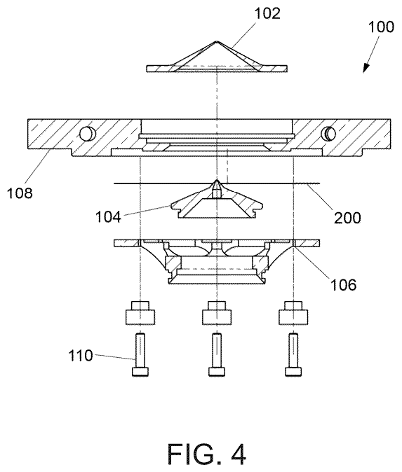

FIGS. 1-4 illustrate various views of an interface assembly 100 for guiding ions from a plasma source to a spectrometer. In particular, FIG. 2 illustrates the cross section as indicated in FIG. 1, FIG. 3 depicts a side elevation, and FIG. 4 depicts an exploded view to illustrate various component parts of the interface assembly.

The interface assembly 100 comprises a sampler cone 102, a skimmer cone 104, a skimmer cone holder 106, a spacer element 200, and a cooling plate 108. While the specific description refers to a cooling plate 108, it will be appreciated that this is an example of a cooling element more generally. The skimmer cone 102 and the sampler cone 104 together facilitate the transfer of ions from the plasma source, which is typically at atmospheric pressure, to an analysis region of the mass spectrometer which is a vacuum or very low pressure. In operation, high temperature ions travel through an orifice 112a of the sampler cone 102, and an ion beam through a smaller orifice 112b of the skimmer cone 104 is generated, which passes into a vacuum in the mass spectrometer. For example, the orifice 112b may be 0.5 mm and the orifice 112a may be 1 mm. Methods of operating a generic interface assembly for a ICP-MS apparatus are known in the art and are not the focus of this disclosure, which instead relates to the provision of a spacer element between at least one of the orifice elements and the cooling plate 108.

The skimmer and sampler cones 102, 104 have operating temperatures of a few hundred degrees Celsius, and thus the components are regulated during operation of the mass spectrometer to prevent damage from the high temperature plasma, which can be up to 10,000°° C., and to reduce interference with the sample (e.g., reduce sample deposition). For example, the temperature at the tip of the skimmer cone 102 may be around 600° C. with 1600W plasma power. To this end, the skimmer and sampler cones 102, 104 are in thermal communication with a cooling plate 108. In particular, as best illustrated in FIG. 4, the skimmer cone 104 is held in place on the mass spectrometer side of the cooling plate 108 with fixings 110. The sampler cone 102 is spaced from the skimmer cone 104 and positioned on an opposing side of the cooling plate 108 (the side facing the plasma source). An interface region 103 between the two cones, within the interface assembly, is maintained at a low pressure, e.g., 100 to 300 Pa. As best illustrated in FIG. 1, the interface assembly 100 is held in place within the spectrometry apparatus using fixings on cooling plate 108.

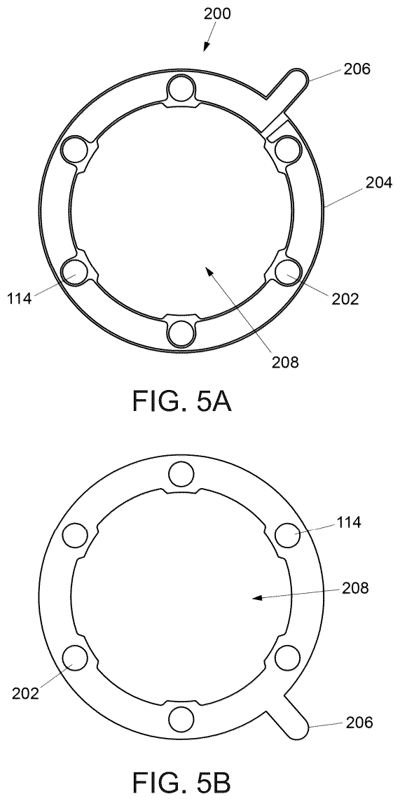

The spacer element 200 is positioned between the skimmer cone holder 106 and the cooling plate 108, which are held together by fixings 110. The skimmer cone 104 sits within the opening 208 (FIG. 5A) of the spacer element 200 and on the skimmer cone holder 106. As described in more detail below with reference to FIGS. 5A-5B, the spacer element 200 is provided such that an electrically isolating body 202 contacts the cooling plate 108 and an electrically conductive layer 204 contacts the skimmer cone holder 106. The spacer element 200 further comprises an electrical contact tab 206 which is configured to enable the supply of voltage to the skimmer cone 102 through the electrically conductive layer 204 of the spacer element 200. In this way, the skimmer cone 104 is electrically isolated from the cooling plate 108 and the sampler cone 102, thus allowing a voltage to be provided to the skimmer cone 104 without interference with the other components of the interface assembly 100.

The skimmer cone 104 is regulated at a temperature not too high as to damage the components and not too low as to interfere with the sample. This is achieved with the provision of the cooling plate 108, which may be regulated with a (liquid or gas) coolant through coolant channels 109, and which acts as a heat sink for the skimmer cone 104. The spacer element 200, which isolates the skimmer cone 104 from the cooling plate 108, is sufficiently thin and/or thermally conductive to enable a heat transfer from the skimmer cone 104 to the cooling plate 108. Other cooling arrangements without coolant channels are equally possible, for example providing the cooling plate 108 with cooling fins or externally applied coolant flows.

The interface assembly 100 may also comprise an O-ring (not shown), positioned between the skimmer 104 and the skimmer holder 106 in O-ring groove 107, which seals the skimmer 104 for vacuum separation between the plasma source and the mass spectrometer. The O-ring must also be regulated within an operating temperature, which can be facilitated by the thermal properties of the spacer element 200.

As discussed above, the spacer element 200 prevents electrical conduction across the interface assembly 100 from the skimmer cone holder 106 to the cooling plate 108 and the sampler cone 102. In this way, the skimmer cone 104 and skimmer cone holder 106 are electrically isolated. It will nevertheless be appreciated that the spacer element 200, or a second spacer element (not shown), may be positioned between the sampler cone 102 and the cooling plate 108 to electrically isolate the sampler cone 102 from the cooling plate 108 and the skimmer cone 104.

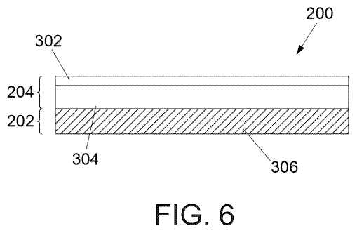

FIGS. 5A-5B and 6 illustrate various views of the spacer element 200. In particular, FIG. 5A depicts the face of the spacer element 200 configured to contact the skimmer cone assembly, whilst FIG. 5B depicts the opposing face of the spacer element 200 configured to abut the cooling plate 108. FIG. 6 depicts a cross-sectional view of one possible configuration for the spacer element 200.

The conductive layer of the spacer element 200 is configured to enable electrical communication with the skimmer cone 104 and/or the skimmer cone holder 106 (though it will be appreciated that alternative options are possible, i.e., contacting and isolating the sampler cone 102). The spacer element comprises an electrically conductive layer 204 atop an electrically isolating body 202. The contact tab 206 extends from the electrically conductive layer 204 and acts as an electrical contact for ease of supplying a voltage to the conductive layer 204. In some implementations, the contact tab is omitted and electrical contact can be made directly onto the electrically conductive layer 204. In either case, a spring contact can be used to connect to the electrically conductive layer 206. The electrically conductive layer 204 is circular in shape, so as to optimise electrical contact with the neighbouring interface component (e.g., skimmer cone holder 106), and is provided with a circumferential gap adjacent to the contact tab 206 so as to prevent the circular shape from forming a closed electrical loop.

The compact form of the spacer element 200 enables minimal influence on the spacing between the skimmer and sampler cones 102, 104. In particular, the spacer element 200 is substantially planar to conform with components of the interface assembly 100 and provide a secure fit. For example, the spacer element 200 comprises through-holes 114 around its periphery which are configured to accommodate fixings 110 attaching the skimmer 104 and the skimmer cone holder 106 to the cooling plate 108. The material properties of the spacer element 200 enable a constant spacing of skimmer 104 relative to the cooling plate 108 during operation of the ICP-MS apparatus, and enable minimal temperature deviation on the skimmer holder 106 and skimmer cone 104.

The form and function of the spacer element 200 advantageously balance electrically insulating properties with thermally conductive properties. For example, as best illustrated in FIG. 6, spacer element 200 comprises a gold layer 302 with a thickness of 3 μm, a copper foil layer 304 with a thickness of 35 μm, and a substrate layer 306 with a thickness of 100 μm.

The substrate layer 306 has electrical insulating properties and acts as a base of the spacer element 200, enabling the spacer element 200 to electrically insulate the cooling plate 108 and the sampler cone 102 from the skimmer cone 104.

The copper foil layer 304 is applied on one side of the polyimide substrate and has a suitable geometry so as to enable electrical contact with the skimmer holder 106 and/or the skimmer cone 104. For example, the copper foil layer 304 may electrically contact the skimmer holder 106 in electrical communication with the skimmer cone 104, or, alternatively, the copper foil layer 304 of the spacer element 200 may contact the skimmer cone 104 directly.

When components of the interface assembly 100 are not inert, reactions can influence sample measurements and may provide interference on discrete m/z values or as a continuous background noise. Copper is reactive and typically oxidises when left uncoated. Therefore, as best illustrated in FIG. 6, the copper layer 304 may be provided with a gold layer 302. Advantageously, the gold layer renders the spacer element 200 sufficiently inert so as not to interfere with sample analysis in the mass spectrometer, and is conductive to maintain the electrical communication with the copper layer 304.

Advantageously, the manufacture of a layered circuit board is easily reproduced without specialist tools or methods. The spacer element 200 can therefore be manufactured economically and in sufficiently large quantities.

The overall thickness of the spacer element 200 of FIG. 6 is 138 um, which achieves, but does not exceed, the required heat transfer rate with the skimmer cone 104. The selected material thicknesses as illustrated in FIG. 6 are chosen depending on the surrounding components, i.e., to cater for the specific thermal conductance of the surrounding components of the interface assembly 100, so as to provide a spacer 200 with an apparatus-appropriate thermal conductance, for example as set out above. Other sensible materials and thicknesses, other than the specific examples illustrated, may be implemented with the herein disclosed spacer element as necessary to cater to specific requirements of different spectrometry apparatuses, as would be easily recognised or tested without undue experimentation.

In particular, it is to be understood that the above description is intended to be illustrative, and not restrictive. Many other implementations will be apparent to those of skill in the art upon reading and understanding the above description. Although the present disclosure has been described with reference to specific example implementations, it will be recognised that the disclosure is not limited to the implementations described but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A spacer element for a plasma interface assembly in a spectrometry apparatus, the plasma interface assembly comprising an orifice element defining an orifice for passing plasma from a plasma source and a cooling element for cooling the orifice element, the spacer element comprising:
an electrically isolating body configured to be inserted between the orifice element and the cooling element, wherein the electrically isolating body is provided with an opening; and
an electrically conductive layer provided on the electrically isolating body to face the orifice element.

2. The spacer element of claim 1, further comprising a contact tab extending from the electrically conductive layer, wherein the contact tab is configured to enable an electrical connection with the electrically conductive layer.

3. The spacer element of claim 2, wherein the contact tab extends substantially radially outward from the electrically conductive layer.

4. The spacer element of claim 1, wherein the electrically isolating body is substantially ring-shaped to allow ions to pass through the orifice when the spacer element is placed between the orifice element and the cooling element.

5. The spacer element of claim 1, wherein the electrically isolating body is between 50 μm and 150 μm thick.

6. The spacer element of claim 1, wherein the electrically isolating body comprises a polyimide layer.

7. The spacer element of claim 1, wherein the electrically conductive layer comprises copper foil.

8. The spacer element of claim 1, wherein the electrically conductive layer comprises copper tracks disposed on a surface of the electrically isolating body.

9. The spacer element of claim 1, wherein the electrically conductive layer is 30 μm to 40 μm thick.

10. The spacer element of claim 1, further comprising a gold layer disposed on the electrically conductive layer.

11. The spacer element of claim 10, wherein the gold layer is 2 μm to 5 μm thick.

12. The spacer element of claim 1, wherein the spacer element has a thermal conductance of 0.1 to 0.5 Watts per metre-Kelvin.

13. The spacer element of claim 1, further comprising through-holes to accommodate fixings securing the orifice element to the cooling element.

14. An interface assembly for a spectrometer comprising an orifice element disposed on a cooling element, the interface assembly comprising:
a spacer element between the orifice element and the cooling element; and
an electrical lead for supplying a voltage to the orifice element, the electrical lead being connected to the spacer element,
wherein the spacer element comprises:
an electrically isolating body configured to be inserted between the orifice element and the cooling element, wherein the electrically isolating body is provided with an opening; and
an electrically conductive layer provided on the electrically isolating body to face the orifice element.

15. The interface assembly of claim 14, wherein the orifice element comprises a skimmer.

16. The interface assembly of claim 14, wherein the orifice element comprises a sampler.

17. The interface assembly of claim 14, wherein the orifice element comprises one or both of an orifice cone and an orifice cone holder.

18. The interface assembly of claim 14, wherein the cooling element comprises a cooling plate.

19. A spectrometry apparatus comprising:
an orifice element disposed on a cooling element; and
an interface assembly comprising:
a spacer element between the orifice element and the cooling element; and
an electrical lead for supplying a voltage to the orifice element, the electrical lead being connected to the spacer element,
wherein the spacer element comprises:
an electrically isolating body configured to be inserted between the orifice element and the cooling element, wherein the electrically isolating body is provided with an opening; and
an electrically conductive layer provided on the electrically isolating body to face the orifice element, and
wherein the spectrometry apparatus is a mass spectrometer or an optical spectrometer.
